(19) United States
(12) Patent Application Publication
(10) Pub. No.: US 2004/0056490 A1
(43) Pub. Date: Mar. 25, 2004

(54) Lift gate latch

(76) Inventor: David M. Thompson, Bricktown, NJ (US)

Correspondence Address: Andrew W. Ludy, 17 Sherwood Way, Landing, NJ, 07850, US

(21) Appl. No.: 10/251,054

(22) Filed: Sep. 20, 2002

(51) Int. Cl. E05B 15/02

(52) U.S. Cl. 292/340

(57) ABSTRACT

A lift gate latch is used in connection with a lift gate and a handrail on a boat. The handrail has a jamb, and the lift gate has at least one stile. The lift gate latch has left and right side walls spaced apart and disposed adjacent the gunwale of the boat. Reinforcing ribs extend along both side walls, which straddle the jamb and the stile. A transverse member and a base member extend between the side walls. A portion of the right side wall has a height lower than the left side wall height, so that the stile can pass easily over it when opening and closing the gate. Fasteners pass through holes in the side walls and engage the gunwale. Bosses are juxtaposed with the holes. The fasteners and bosses strengthen the side wall adjacent each hole.

### CROSS-REFERENCE TO RELATED APPLICATIONS

Not Applicable

### STATEMENT REGARDING FEDERALLY SPONSORED RESEARCH OR DEVELOPMENT

Not Applicable

### BACKGROUND OF THE INVENTION

This invention relates to the field of gates, and more particularly to a lift gate closure latch for a patio boat.

Patio and pontoon boats have greatly increased in number and popularity in recent years. These boats are typically equipped with aluminum handrails along the port and starboard sides, and across the bow and stem. The handrails include gates by which to embark and disembark, one on each side and often one forward. These are typically lift gates. A lift gate slides vertically on the same hinges on which it is pivotally mounted. The sliding movement allows a latch to engage as the gate is lowered, in order to secure the gate against opening. Lifting the gate will disengage the latch so that the gate will swing open.

One type of gate latch comprises a hook, or U-shaped element engaging a loop or eye element. The components must first be fabricated. One element is welded or bolted to the gate, and the other to the jamb. This process is labor intensive. The latch rattles when the boat is underway, and it is not very attractive.

Another type of gate latch comprises a generally U-shaped bracket mounted on the boat gunwale. The gate stile fits into the bracket as the gate is lowered. This latch is typically molded of plastic. It has a base portion with the mounting screws, and upright walls, which are prone to breakage.

Accordingly, there is a need to provide a lift gate latch that can be installed quickly and easily with a minimum of skill.

There is a further need to provide a lift gate latch of the type described and that is reinforced so that the walls will not break.

There is a yet further need to provide a lift gate latch of the type described and that will not rattle when the boat is underway.

There is a still further need to provide a lift gate latch of the type described and that will not rust or corrode, and yet is strong and very attractive.

There is another need to provide a lift gate latch of the type described and that can be manufactured cost-effectively in large quantities of high quality.

### BRIEF SUMMARY OF THE INVENTION

In accordance with the present invention, there is provided a lift gate latch for use in connection with a lift gate and a handrail on a boat. The boat has a gunwale, and the handrail has a jamb. The jamb and the boat gunwale define a support structure. The lift gate has a hinge, and at least one stile. The lift gate is able to rise upwardly on the hinge, and is able to pivot on the hinge between a closed and an open position. The lift gate latch comprises a left side wall and a right side wall, the side walls being spaced apart. Each side wall extends between opposite upper and lower edges. The left and right side walls straddle the jamb and the stile. The left and right side wall lower edges are disposed adjacent the gunwale. The left and right side walls each include at least one hole extending through the wall between the upper and lower edges. At least two fasteners are provided, each fastener passing through one of the holes. The fasteners engage the support structure to fasten the lift gate latch to the support structure. The fasteners pass through the full depth of the walls. They thereby serve to strengthen the side walls, solving a major problem. A first boss extends between the upper and lower edges of the left side wall, and is juxtaposed with the first hole. A second boss extends between the upper and lower edges of the right side wall, and is juxtaposed with the second hole. The bosses strengthen the side wall adjacent each hole. A transverse member extends between the left and right side walls intermediate the first and second ends. The transverse member extends between the upper and lower edges, and is disposed adjacent the jamb. A base member extends transversely between the left and right side walls. Thus, upon opening the lift gate, the lift gate will rise, the stile will pass above the upper edge and the gate will be pivoted open. Upon closing the lift gate, the gate will be pivoted closed, and the stile will pass above the upper edge. The lift gate will then be lowered such that the stile will be captured between the left and right side walls, thereby latching the gate.

### BRIEF DESCRIPTION OF THE SEVERAL VIEWS OF THE DRAWING

A more complete understanding of the present invention may be obtained from consideration of the following description in conjunction with the drawing, in which:

FIG. 1 is a partial, perspective view of a boat gunwale, handrail, gate, and hinge, showing installation of a gate latch constructed in accordance with the invention;

FIG. 2 is a close-up, partial, perspective view of the gate latch installation of FIG. 1;

FIG. 3 is a right side elevational view of the gate latch of FIG. 1;

FIG. 4 is a second end elevational view of the gate latch of FIG. 1;

FIG. 5 is a first end elevational view of the gate latch of FIG. 1;

FIG. 6 is a top view of the gate latch of FIG. 1;

FIG. 7 is a left side elevational view of the gate latch of FIG. 1, taken along lines 7-7 of FIG. 4;

FIG. 8 is a perspective view of the gate latch of FIG. 1;

FIG. 9 is a right side elevational view of another gate latch constructed in accordance with the invention;

FIG. 10 is a second end elevational view of the gate latch of FIG. 9;

FIG. 11 is a first end elevational view of the gate latch of FIG. 9;

FIG. 12 is a top view of the gate latch of FIG. 9;

FIG. 13 is a left side elevational view of the gate latch of FIG. 9, taken along lines 13-13 of FIG. 10; and

FIG. 14 is a perspective view of the gate latch of FIG. 9.

### DETAILED DESCRIPTION OF THE INVENTION

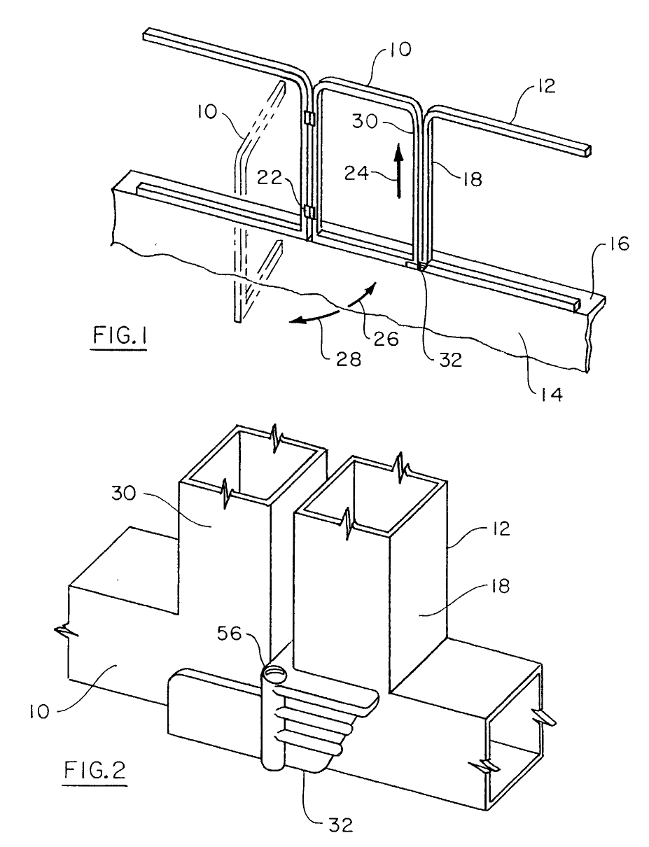

Referring now to the drawing, and especially to FIGS. 1 and 2 thereof, a lift gate latch is shown at 32, and is for use in connection with a lift gate 10 and a handrail 12 on a boat 14. The boat 14 has a gunwale 16. The handrail 12 has a jamb 18. The jamb 18 and the boat gunwale 16 define a support structure 20. The lift gate 10 has a hinge 22. The lift gate 10 is able to rise upwardly on the hinge 22, as shown by arrow 24. The lift gate 10 is able to pivot on the hinge 22 between a closed and an open position, shown by arrows 26 and 28 respectively. The lift gate 10 has at least one stile 30.

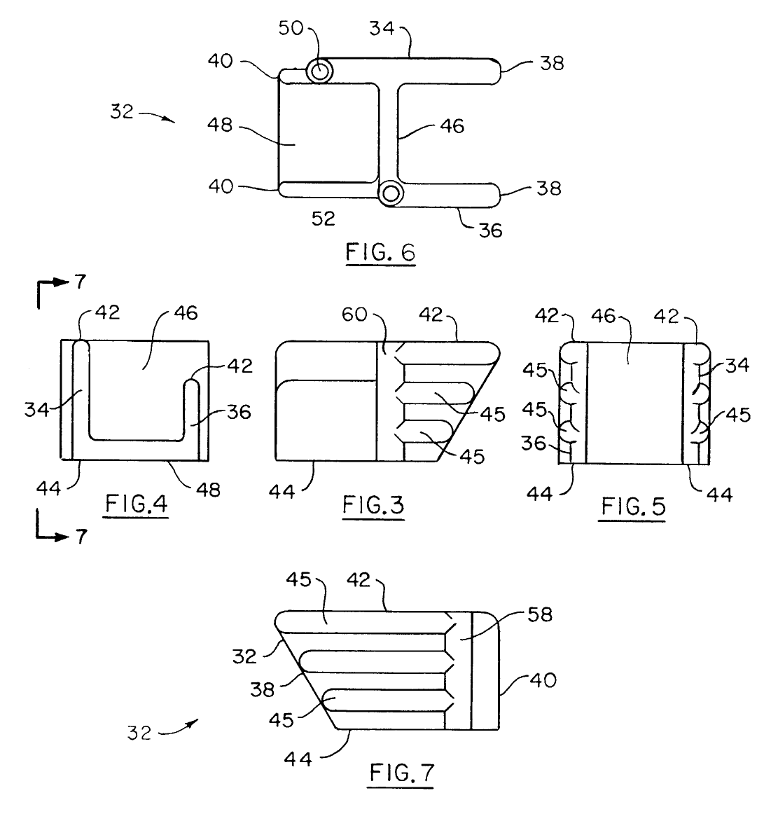

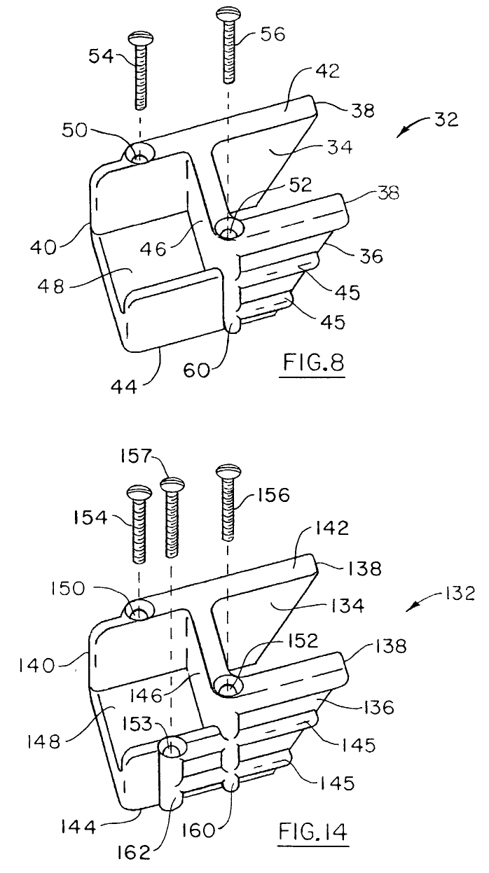

Turning now to FIGS. 3, 4, 5, 6, 7, and 8, as well as FIGS. 1 and 2, the lift gate latch 32 comprises a left side wall 34 and a right side wall 36. Each side wall extends between opposite first 38 and second 40 ends, and between opposite upper 42 and lower 44 edges. Reinforcing ribs 45 extend along the left 34 and right 36 side walls. The upper edges 42 are at a predetermined height above the lower edges 44. The side walls 34 and 36 are parallel and spaced apart. The left 34 and right 36 side walls straddle the jamb 18 and the stile 30, as shown in FIG. 2. The left and right side wall lower edges 44 are disposed adjacent the gunwale 16. A transverse member 46 extends between the left 34 and right 36 side walls intermediate the first 38 and second 40 ends. The transverse member 46 extends between the upper 42 and lower 44 edges. The transverse member 46 is disposed adjacent the jamb 18. The right side wall upper edge 42 between the transverse member 46 and the second end 40 has a height lower than the predetermined height, so as to facilitate passing of the stile 18 above the upper edge 42. A base member 48 extends between the left 34 and right 36 side walls, and extends from the transverse member 46 to the first end 38. The base member 48 is disposed adjacent the gunwale 16. The lift gate latch 32 typically will be injection molded from a thermoplastic or thermoset resin.

The left side wall 34 includes a first hole 50 extending between the upper 42 and lower 44 edges. The right side wall 36 includes a second hole 52 extending between the upper 42 and lower 44 edges. Fastening means is provided for fastening the lift gate latch 32 to the support structure 20. The fastening means includes a first fastener 54 passing through the first hole 50 and a second fastener 56 passing through the second hole 52. The fasteners 54 and 56 engage the gunwale 16 to fasten the lift gate latch 32 to the gunwale 16. The fasteners 54 and 56 typically will be machine screws secured with nuts and washers (not shown) under the gunwale 16. A first boss 58 extends between the upper 42 and lower 44 edges of the left side wall 34 and is juxtaposed with the first hole 50. A second boss 60 extends between the upper 42 and lower 44 edges of the right side wall 36 and is juxtaposed with the second hole 52, so as to strengthen the side wall adjacent each hole.

Thus, upon opening the lift gate 10, the lift gate 10 will rise, the stile 30 will pass above the upper edge 42 and the gate 10 will be pivoted open. Conversely, upon closing the lift gate 10, the gate 10 will be pivoted closed, the stile 30 will pass above the upper edge 42, and the lift gate 10 will be lowered such that the stile 30 will be captured between the left 34 and right 36 side walls, thereby securely latching the gate 10.

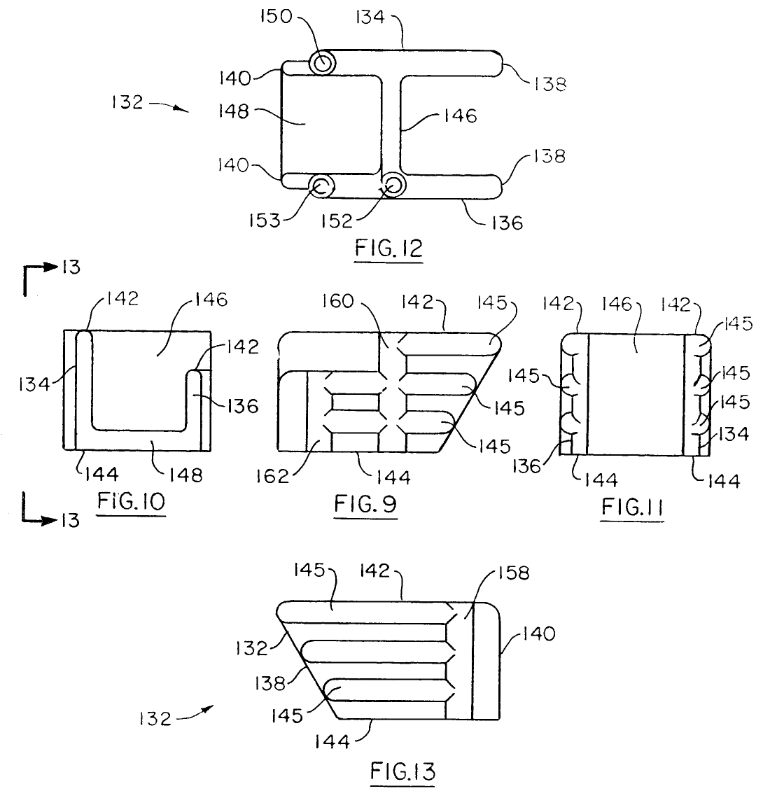

Referring now to FIGS. 9, 10, 11, 12, 13, and 14, another embodiment of the lift gate latch is shown at 132. Latch 132 is similar to latch 32, in that it comprises a left side wall 134 and a right side wall 136. Each side wall extends between opposite first 138 and second 140 ends, and between opposite upper 142 and lower 144 edges. Reinforcing ribs 145 extend along the left 134 and right 136 side walls. The upper edges 142 are at a predetermined height above the lower edges 144. The side walls 134 and 136 are parallel and spaced apart. A transverse member 146 extends between the left 134 and right 136 side walls intermediate the first 138 and second 140 ends. The transverse member 146 extends between the upper 142 and lower 144 edges. The right side wall upper edge 142 between the transverse member 146 and the second end 140 has a height lower than the predetermined height, so as to facilitate passing of the stile 18 above the upper edge 142. A base member 148 extends between the left 134 and right 136 side walls, and extends from the transverse member 146 to the first end 138.

The left side wall 134 includes a first hole 150 extending between the upper 142 and lower 144 edges. The right side wall 136 includes a second hole 152 extending between the upper 142 and lower 144 edges. The right side wall 136 also includes a third hole 153 extending between the upper 142 and lower 144 edges adjacent the second end 140. The fastening means includes a first fastener 154 passing through the first hole 150, a second fastener 156 passing through the second hole 152, and a third fastener 157 passing through the third hole 153. A first boss 158 extends between the upper 142 and lower 144 edges of the left side wall 134 and is juxtaposed with the first hole 150. A second boss 160 extends between the upper 142 and lower 144 edges of the right side wall 136 and is juxtaposed with the second hole 152. A third boss 162 extends between the upper 142 and lower 144 edges of the right side wall 136 and is juxtaposed with the third hole 153.

A latching method is also disclosed for latching a lift gate. The method comprises the steps of extending a left side wall 134 and a right side wall 136 between opposite first 138 and second 140 ends, and between opposite upper 142 and lower 144 edges. Next, establishing a predetermined height for the left side wall and the right side wall upper edges 142, then spacing the side walls apart and parallel, and straddling the jamb 18 and the stile 30 with the left 134 and right 136 side walls. Next, disposing the left and right side wall lower edges 144 adjacent the gunwale 16, extending a base member 148 transversely between the left 134 and right 136 side walls, and disposing the base member 148 adjacent the gunwale 16. Next, extending a first hole 150 through the left side wall 134 between the upper 142 and lower 144 edges, then passing a first fastener 154 through the first hole 150, and strengthening the left side wall 134 with the first fastener 154. Similarly, extending a second hole 152 through the right side wall 136 between the upper 142 and lower 144 edges, then passing a second fastener 156 through the second hole 152, and strengthening the right side wall 136 with the second fastener 156, and fastening the lift gate latch 132 to the gunwale 16 with the fasteners.

Further steps comprise extending a transverse member 146 between the left 134 and right 136 side walls, disposing the transverse member 146 adjacent the jamb 18, and intermediate the first 138 and second 140 ends, and extending the transverse member 146 between the upper 142 and lower 144 edges, then extending the base member 148 from the transverse member 146 to the first end 138. Next, extending a first boss 158 between the upper 142 and lower 144 edges of the left side wall 134, juxtaposing the first boss 158 with the first hole 150, and strengthening the left side wall 34 adjacent the first hole 150 with the first boss 158. Next, extending a second boss 160 between the upper 142 and lower 144 edges of the right side wall 136, juxtaposing the second boss 160 with the second hole 152, and strengthening the right side wall 136 adjacent the second hole 152 with the second boss 160. Next, lowering the right side wall upper edge 142 between the transverse member 146 and the second end 140 to a height lower than the predetermined height, so as to facilitate passing of the stile 30 above the upper edge 142.

Yet further steps include extending a third hole 153 between the upper 142 and lower 144 edges of the right side wall 136 adjacent the second end 140, extending a third boss 162 between the upper 142 and lower 144 edges of the right side wall 136, then juxtaposing the third boss 162 with the third hole 153, and strengthening the right side wall 136 adjacent the third hole 153 with the third boss 162. Next, passing a third fastener 157 through the third hole 153, and strengthening the right side wall 136 with the third fastener 157, then fastening the lift gate latch 132 to the gunwale 16 with the third fastener 157. A final step includes extending reinforcing ribs 145 along the left 134 and right 136 side walls, so as to strengthen the walls.

Numerous modifications and alternative embodiments of the invention will be apparent to those skilled in the art in view of the foregoing description. Accordingly, this description is to be construed as illustrative only and is for the purpose of teaching those skilled in the art the best mode of carrying out the invention. Details of the structure may be varied substantially without departing from the spirit of the invention and the exclusive use of all modifications that will come within the scope of the appended claims is reserved.

The embodiments of the invention in which an exclusive property or privilege is claimed are defined as follows:

1. A lift gate latch, for use in connection with a lift gate and a handrail on a boat, the boat having a gunwale, the handrail having a jamb, the jamb and the boat gunwale defining a support structure, the lift gate having a hinge, the lift gate being able to rise upwardly on the hinge, the lift gate being able to pivot on the hinge between a closed and an open position, the lift gate having at least one stile, the lift gate latch comprising:
(a) a left side wall and a right side wall, each side wall extending between opposite upper and lower edges, the left and right side walls being spaced apart and straddling the jamb and the stile, the left and right side wall lower edges being disposed adjacent the gunwale, the left and right side walls each including at least one hole extending through the wall between the upper and lower edges;
(b) at least two fasteners, each fastener passing through one of the holes and engaging the support structure to fasten the lift gate latch to the support structure and strengthen the side walls; and
(c) a base member extending transversely between the left and right side walls, so that upon opening the lift gate, the lift gate will rise, the stile will pass above the upper edge and the gate will be pivoted open, and upon closing the lift gate, the gate will be pivoted closed, the stile will pass above the upper edge, and the lift gate will be lowered such that the stile will be captured between the left and right side walls, thereby latching the gate.

2. The lift gate latch of claim 1, further comprising:
(a) a transverse member extending between the left and right side walls intermediate the first and second ends, and extending between the upper and lower edges, the transverse member being disposed adjacent the jamb; and
(b) a first boss extending between the upper and lower edges of the left side wall and juxtaposed with the first hole, and a second boss extending between the upper and lower edges of the right side wall and juxtaposed with the second hole, so as to strengthen the side wall adjacent each hole.

3. A lift gate latch, for use in connection with a lift gate and a handrail on a boat, the boat having a gunwale, the handrail having a jamb, the lift gate having a hinge, the lift gate being able to rise upwardly on the hinge, the lift gate being able to pivot on the hinge between a closed and an open position, the lift gate having at least one stile, the lift gate latch comprising:
(a) a left side wall and a right side wall, each side wall extending between opposite first and second ends, and between opposite upper and lower edges, the upper edges being a predetermined height above the lower edges, the left and right side walls being parallel, spaced apart, and straddling the jamb and the stile, the left and right side wall lower edges being disposed adjacent the gunwale, the left side wall having a first hole extending between the upper and lower edges, and the right side wall having a second hole extending between the upper and lower edges;
(b) a first boss extending between the upper and lower edges of the left side wall and juxtaposed with the first hole, and a second boss extending between the upper and lower edges of the right side wall and juxtaposed with the second hole, so as to strengthen the side wall adjacent each hole;
(c) a first fastener passing through the first hole to strengthen the left side wall, and a second fastener passing through the second hole to strengthen the right side wall, the fasteners engaging the gunwale to fasten the lift gate latch to the gunwale;
(d) a base member extending between the left and right side walls, and extending from the transverse member to the first end, the base member being disposed adjacent the gunwale; and
(e) a transverse member extending between the left and right side walls intermediate the first and second ends, and extending between the upper and lower edges, the transverse member being disposed adjacent the jamb, so that upon opening the lift gate, the lift gate will rise, the stile will pass above the upper edge and the gate will be pivoted open, and upon closing the lift gate, the gate will be pivoted closed, the stile will pass above the upper edge, and the lift gate will be lowered such that the stile will be captured between the left and right side walls, thereby securely latching the gate.

4. The lift gate latch of claim 3, further comprising reinforcing ribs extending along the left and right side walls to strengthen the side walls.

5. The lift gate latch of claim 3, wherein:
(a) the right side wall includes a third hole extending between the upper and lower edges adjacent the second end;
(b) the right side wall includes a third boss extending between the upper and lower edges of the right side wall, the third boss being juxtaposed with the third hole to strengthen the right side wall adjacent the hole; and
(c) the lift gate latch includes a third fastener passing through the third hole to strengthen the right side wall, the third fastener engaging the gunwale to fasten the lift gate latch to the gunwale.

6. The lift gate latch of claim 3, wherein the right side wall upper edge between the transverse member and the second end has a height lower than the predetermined height, so as to facilitate passing of the stile above the upper edge.

7. A latching method for latching a lift gate, for use in connection with a lift gate and a handrail on a boat, the boat having a gunwale, the handrail having a jamb, the lift gate having a hinge, the lift gate being able to rise upwardly on the hinge, the lift gate being able to pivot on the hinge between a closed and an open position, the lift gate having at least one stile, the method comprising the steps of:
(a) extending a left side wall and a right side wall between opposite first and second ends, and between opposite upper and lower edges;
(b) establishing a predetermined height for the left side wall and the right side wall upper edges;
(c) spacing the side walls apart and parallel;
(d) straddling the jamb and the stile with the left and right side walls;
(e) disposing the left and right side wall lower edges adjacent the gunwale;
(f) extending a base member transversely between the left and right side walls;
(g) disposing the base member adjacent the gunwale;
(h) extending a first hole through the left side wall between the upper and lower edges;
(i) passing a first fastener through the first hole;
(j) strengthening the left side wall with the first fastener;
(k) extending a second hole through the right side wall between the upper and lower edges;
(l) passing a second fastener through the second hole;
(m) strengthening the right side wall with the second fastener; and
(n) fastening the lift gate latch to the gunwale with the fasteners.

8. The latching method of claim 7, further comprising the steps of:
(a) extending a transverse member between the left and right side walls; and
(b) disposing the transverse member adjacent the jamb.

9. The latching method of claim 8, further comprising the steps of:
(a) disposing the transverse member intermediate the first and second ends;
(b) extending the transverse member between the upper and lower edges; and
(c) extending the base member from the transverse member to the first end.

10. The latching method of claim 9, further comprising the steps of:
(a) extending a first boss between the upper and lower edges of the left side wall;
(b) juxtaposing the first boss with the first hole;
(c) strengthening the left side wall adjacent the first hole with the first boss;
(d) extending a second boss between the upper and lower edges of the right side wall;
(e) juxtaposing the second boss with the second hole; and
(f) strengthening the right side wall adjacent the second hole with the second boss.

11. The latching method of claim 10, further comprising the step of lowering the right side wall upper edge between the transverse member and the second end to a height lower than the predetermined height, so as to facilitate passing of the stile above the upper edge.

12. The latching method of claim 10, further comprising the steps of:
(a) extending a third hole between the upper and lower edges of the right side wall adjacent the second end;
(b) extending a third boss between the upper and lower edges of the right side wall;
(c) juxtaposing the third boss with the third hole;
(d) strengthening the right side wall adjacent the third hole with the third boss;
(e) passing a third fastener through the third hole;
(f) strengthening the right side wall with the third fastener; and
(g) fastening the lift gate latch to the gunwale with the third fastener.

13. The latching method of claim 7, further comprising the step of extending reinforcing ribs along the left and right side walls, so as to strengthen the walls.
